(19) United States
(12) Patent Application Publication
(10) Pub. No.: US 2006/0059240 A1
(43) Pub. Date: Mar. 16, 2006

(54) Method for multi-identifier login of an instant messaging system

(75) Inventors: Pengcheng Qin, Shenzhen (CN); Shan Lu, Shenzhen (CN); Jiangui Zhang, Shenzhen (CN)

Correspondence Address: HARNESS, DICKEY & PIERCE, P.L.C., P.O. BOX 828, BLOOMFIELD HILLS, MI, 48303, US

(73) Assignee: Tencent Technology (Shenzhen) Company Limited, Guangdong (CN)

(21) Appl. No.: 11/239,682

(22) Filed: Sep. 29, 2005

Related U.S. Application Data
(63) Continuation of application No. PCT/CN04/00627, filed on Jun. 11, 2004.

(30) Foreign Application Priority Data
Jun. 13, 2003 (CN) 03126839.0

(51) Int. Cl. G06F 15/16

(52) U.S. Cl. 709/207

(57) ABSTRACT

A method for multi identifier log in of instant messaging system, setting corresponding relation between more than one user identifiers; after receiving log in request, instant messaging system allows the user to log in according to the corresponding relation among the said user identifiers. The present can support multi kinds of user identifier to log in simultaneously, which solves the problem that instant messaging system cannot support multi kinds of user identifier to log in simultaneously, making it more convenient for the user to log in an instant messaging system, and interesting quality of an instant messaging system is increased. The present invention is of stronger practicability.

### CROSS-REFERENCE TO RELATED APPLICATIONS

This application is a continuation of International Application No. PCT/CN2004/000627 filed on Jun. 11, 2004. This application claims the benefit of Chinese Application No. 03126839.0 filed on Jun. 13, 2003. The disclosures of the above applications are incorporated herein by reference.

### FIELD OF THE INVENTION

The present invention relates to network communication service technique, more particularly to a method for multi-identifier log in of instant messaging system.

### BACKGROUND OF THE INVENTION

Network Instant Messaging (IM) service is a messaging service based on the Internet, mainly implementing network instant messaging function. Instant messaging service is widely applied and approbated on the Internet. Moreover, Internet instant messaging service is also extending in direction of combining with network virtual community gradually, which embodies development direction of network instant messaging service.

Before entering instant messaging system and enjoying IM service, the user must log in first of all, and the user must input user identifier and corresponding password before logging in. There are generally two kinds of user identifier: one is digital user identifier, such as User Identifier Number (UIN); the other is string identifier, such as email address, nickname, etc.

In current instant messaging system, only single identifier log in is supported, for instance: only UIN+password log in, or email address+password log in is supported. However, with the popularization and development of network service, a user often registers many different IM services, under this circumstances, the user may forget the user identifier for logging in this instant messaging system or mix up this user identifier with those registered in other network services, so the manner of single user identifier log in can bring much inconvenience to the users. What's more, because all instant messaging services adopt the same log in manner and similar log in interface, the user is easy to be bored, so that interesting quality of instant messaging service is reduced.

### SUMMARY OF THE INVENTION

The main object of the present invention is to provide a method for multi-identifier log in of instant messaging system, so as to solve the problem in existing technology that instant messaging tool cannot support multi kinds of identifier log in simultaneously.

To obtain the above object, A method for multi-identifier log in of instant messaging system, comprising:

A. setting corresponding relations among more than one user identifiers;

B. after receiving a log-in request, instant messaging system allowing the user to log in according to the said corresponding relations among multi user identifiers.

wherein, setting at least one mapping database to store the said corresponding relations among more than one user identifiers.

wherein, the said more than one identifiers in this method, comprising: basic identifier of instant messaging system and secondary identifier.

wherein, the said step A comprising: basic identifier of instant messaging system being bound with at least one secondary identifier.

wherein, the said step A comprising: when the user is registering and applying for a basic identifier, instant messaging system automatically setting up corresponding relation between this secondary identifier and the basic identifier according to the secondary identifier in user's information.

wherein before the said basic identifier is bound with the said secondary identifier, further comprising: transmitting verification information of this secondary identifier to the identification entity corresponding with the secondary identifier by way of instant messaging system, the basic identifier being bound with secondary identifier if this secondary identifier passes the verification.

wherein, the said binding procedure thereof comprising:

a) instant messaging system obtaining basic identifier, secondary identifier as well as other relevant information;

b) instant messaging system transmitting relevant verification information to a identification entity corresponding with current secondary identifier;

c) instant messaging system verifying the secondary identifier according to the obtained corresponding feedback information;

d) after the secondary identifier is verified, current basic identifier and secondary identifier being stored in related mapping database one by one correspondingly.

wherein, the said basic identifier of this method is User Identify Number (UIN) or E-mail address; the said secondary identifier is cell phone number or E-mail address or nick name or combination of the former two or three identifiers.

wherein, the said step B comprising:

if instant messaging system receives a log-in request adopting a secondary identifier, instant messaging system obtaining the basic identifier corresponding with this secondary identifier in this log-in request according to the said corresponding relation, and then executing basic identifier log in procedure with the obtained basic identifier.

wherein, the said log-in request that adopts a secondary identifier in this method comprising secondary identifier and corresponding password of basic identifier, after the said instant messaging system obtains the basic identifier corresponding with the secondary identifier in this request according to the binding relation, the method further comprising: searching the basic identifier database that stores basic identifier and its corresponding password in instant messaging system, judging whether the basic identifier and its corresponding password found in basic identifier database match the basic identifier obtained from the binding relation and corresponding password in the log-in request, if yes, the said basic identifier log-in procedure being executed.

wherein, the said step B comprising:

directly logging in the log-in server of instant messaging server through the secondary identifier, and then verifying whether the secondary identifier is a legal identifier corresponding with the basic identifier according to the said corresponding relation.

It can be seen from the above description that, binding relations between original basic identifier and other Secondary Identifiers (SID) are set inside the instant messaging system, when the user logs in the instant messaging system through a secondary identifier, corresponding basic identifier is obtained through the mapping data bank in the first place, then the user logs in the instant messaging system through the obtained basic identifier, therefore, the present invention can support multi-identifier log in, the problem that instant messaging system cannot support multi-identifier log in of the existing technique is solved, so that the user can log in an instant messaging system more conveniently and flexibly, interesting quality of an instant messaging system is increased, and the present invention is of stronger practicability.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flowchart illustrating cell phone number binding procedure in the present invention;

FIG. 2 is a flowchart illustrating E-MAIL address binding procedure in the present invention;

FIG. 3 is a flowchart illustrating procedure of logging in an instant messaging system by adopting scheme of the present invention.

### DETAILED DESCRIPTION OF THE PREFERRED EMBODIMENTS

The following description of the preferred embodiment(s) is merely exemplary in nature and is in no way intended to limit the invention, its application, or uses.

The object of the present invention is to make the user log in an instant messaging system by way of multi identifiers, considering that instant messaging system can log in using one kind of identifier in existing technique, in the present invention, for description convenience, this kind of identifier is called basic identifier of this instant messaging system, and basic identifier is a user's unique identifier in an instant messaging system of existing technique, while the user's other identifiers are called secondary identifiers.

The present invention will be described in detail with reference to the accompanying drawings.

Before the user accepts secondary identifier log-in service, instant messaging system finishes binding related identifier data by setting up corresponding relations between the basic identifier and other secondary identifiers, and stores the binding information in a mapping database.

During the procedure of setting up corresponding relations between the basic identifier and other secondary identifiers, related verification information is transmitted to corresponding identification entity of the said secondary identifier through instant messaging system, if the secondary identifier proves the verification, then finish related identifier data binding. The specific binding procedure thereof is as follows:

instant messaging system obtains the basic identifier, secondary identifier and related information thereof;

instant messaging system transmits related verification information to the corresponding identifier entity of this secondary identifier;

instant messaging system verifies the secondary identifier according to corresponding feedback information;

if the secondary identifier passes the verification, binding between basic identifier and secondary identifier is completed, and binding information is stored in relevant mapping database.

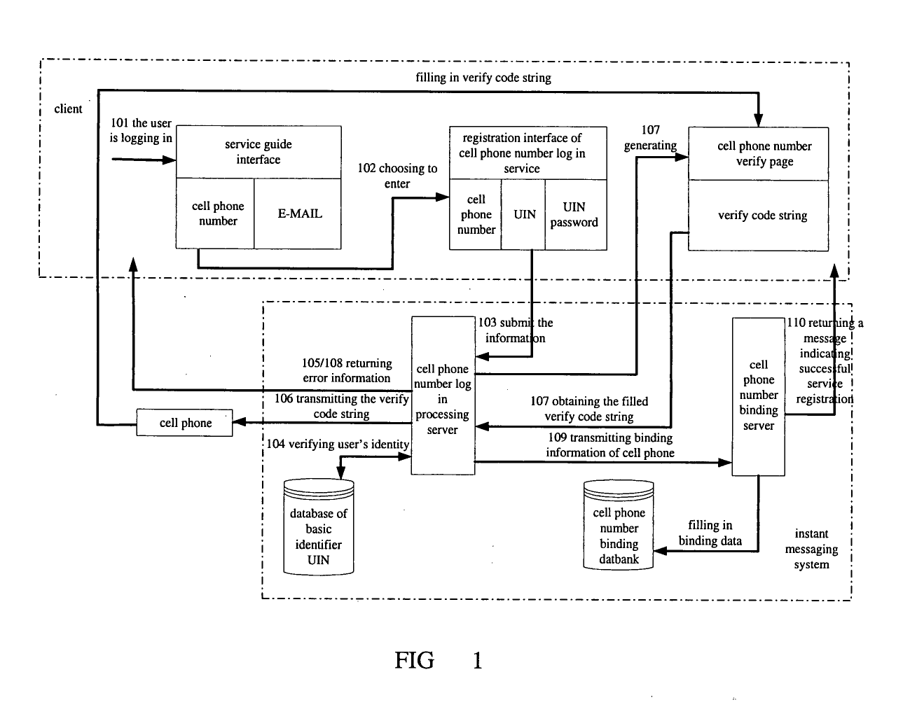

Taking a binding procedure with basic identifier as UIN and secondary identifier as cell phone number for example, specific operations will be described in detain hereinafter, as shown in FIG. 1:

Step 101: the user logs on other identifier service guide at the client and service guide interface is displayed at the client.

The service guide interface presents the user whether to choose cell phone number binding or E-MAIL address binding.

Step 102: the user chooses cell phone number binding, enters registration interface of cell phone number log in service, fills in and submits a cell phone number, this user's basic identifier UIN as well as corresponding password.

Step 103: client transmits service apply request as well as related information, such as the filled cell phone number, basic identifier UIN and corresponding password of this user, to cell phone number log in processing server of the instant messaging system, then cell phone number log in processing server obtains the basic identifier UIN, corresponding password and cell phone number from the information.

Step 104: according to the basic identifier UIN and corresponding password thereof, cell phone number log in processing server searches the database of basic identifier UIN, so as to verify this user's identity.

Step 105: if the user's identity passes the verification, step 106 will be executed; otherwise, cell phone number log in processing server will transmit error information to the client and finish the flow.

Step 106: cell phone number log in processing server submits verification corresponding with the cell phone number to the user, namely transmitting verify code string to this cell phone.

Step 107: cell phone number log in processing server generates cell phone number verify page at the client, the user obtains the verify code string from the cell phone, fills the verify code string in cell phone number verify page and submit, and then instant messaging system verifies the verify code string information.

Step 108: if the verify code string input by the user is the same as that sent by cell phone number log in processing server, which indicates a successful verification, step 109 will be executed; if the verify code string input by the user is not the same as that sent by cell phone number log in processing server, which indicates an unsuccessful verification, cell phone number log in processing server will transmit error information to the client.

Step 109: cell phone number log in processing server transmits cell phone binding information that comprises cell phone number of current user, basic identifier UIN and corresponding password of the UIN to cell phone number binding server in instant messaging system, cell phone number binding server fills in corresponding mapping database in binding manner with the said cell phone number of current user, basic identifier UIN and corresponding password of the UIN, namely cell phone number binding database, so as to finish binding the basic identifier UIN with cell phone number.

Step 110: cell phone number binding server sends a message indicating successful service registration to the client.

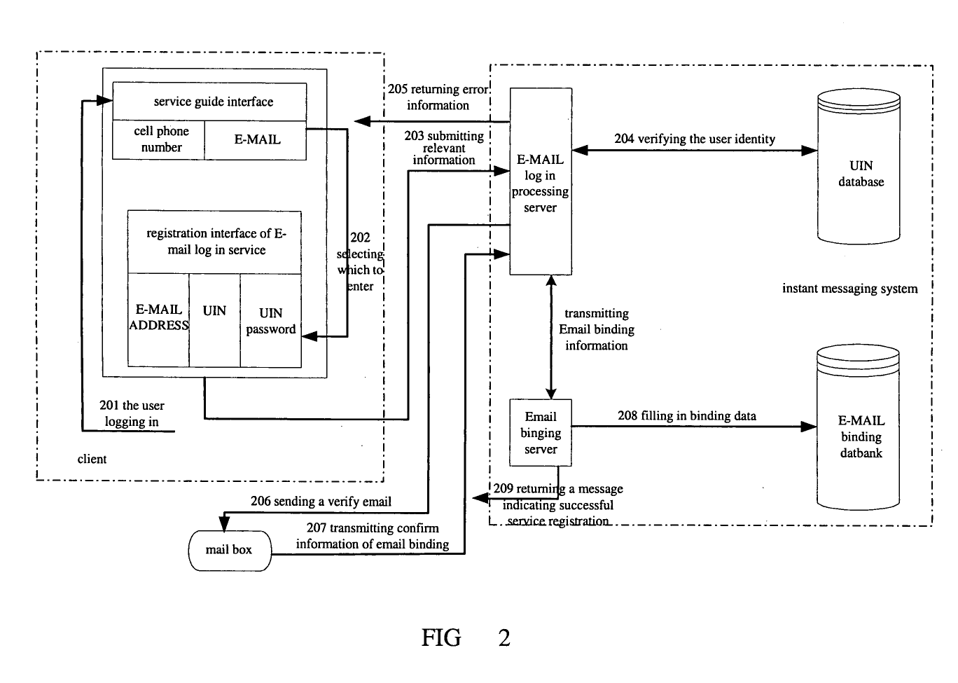

Taking a binding procedure with basic identifier as UIN and secondary identifier as E-MAIL address for example, specific operations will be described in detain hereinafter, as shown in FIG. 2:

Step 201: the user logs on other user identifier service guide at the client and service guide interface is displayed at the client.

The service guide interface presents the user whether to choose cell phone number binding or E-MAIL address binding.

Step 202: the user chooses E-MAIL address binding, enters registration interface of E-MAIL log in service, fills in and submits an E-MAIL address, this user's basic identifier UIN as well as corresponding password of the UIN.

Step 203: the client transmits service apply request as well as related information, such as the filled E-MAIL address, basic identifier UIN and corresponding password of the UIN of this user, to E-MAIL log in processing server in the instant messaging system, then E-MAIL log in processing server obtains the basic identifier UIN, corresponding password and E-MAIL from the information.

Step 204: according to the basic identifier UIN and corresponding password thereof, E-MAIL log in processing server searches the database of basic identifier UIN, so as to verify this user's identity.

Step 205: if the user's identity passes the verification, step 206 will be executed; otherwise, E-MAIL log in processing server will transmit error information to the client and finish the flow.

Step 206: E-MAIL log in processing server transmits verification email to identification entity corresponding with the E-MAIL, namely transmitting verification email to this email box.

Step 207: the user clicks confirming link in the verification email of this email box so as to transmit confirm information of E-MAIL binding to E-MAIL log in processing server, E-MAIL log in processing server receives this confirm information, which indicates the verification is passed.

Step 208: E-MAIL log in processing server transmits E-MAIL binding information that comprises E-MAIL address of current user, basic identifier UIN and corresponding password of the UIN to E-MAIL binding server in instant messaging system, E-MAIL binding server fills in the corresponding mapping data bank in binding manner with the said E-MAIL address of current user, basic identifier UIN and corresponding password of the UIN, namely E-MAIL binding data bank, so as to finish binding the basic identifier UIN with the E-MAIL address.

Step 209: E-MAIL binding server sends a message indicating successful service registration to the client.

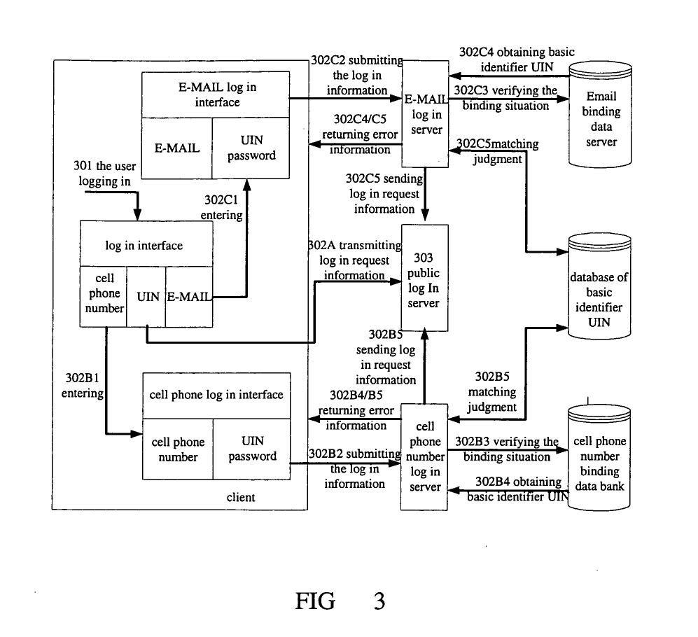

After binding relation between the basic identifier and secondary identifier is set up in instant messaging system, the user can log in the instant messaging system through the bound secondary identifier. Specific operations of logging in an instant messaging system by adopting the present invention will be described in detail hereinafter, as shown in FIG. 3:

Step 301: the user enters log in interface at the client, and the log in interface comprises log in guide service of multi identifiers, such as cell phone number, UIN, E-MAIL, and so on, the user can select a kind of log in identifier;

Step 302: if the user selects basic identifier UIN, step 302A will be executed; if the user selects cell phone number log in, step 302B will be executed; if the user selects E-MAIL address log in, step 302C will be executed.

302A: if the user selects basic identifier UIN, the client will send a log in request to public log in server in instant messaging system, then step 303 is executed.

302B comprises the following step 302B1˜302B5:

302B1: if the user selects cell phone number log in, the client enters a cell phone number log in interface, the user fills in the cell phone number and basic identifier UIN password.

302B2: the client submits log in information comprising this cell phone number and UIN password to cell phone number log in server in the instant messaging system;

302B3: cell phone number log in server searches cell phone number binding database to verify binding situation of this cell phone number;

302B4: if the cell phone number submitted by the user is already bound with a basic identifier UIN, obtaining this basic identifier UIN, and step 302B5 will be executed; if the cell phone number submitted by the user is not bound with any basic identifier UIN, cell phone number log in server will send error information to the client and finish the procedure;

302B5: cell phone number log in server searches the database of basic identifier UIN, and judges whether the basic identifier UIN and corresponding password in this database are the same as the basic identifier UIN obtaining from the cell number binding database and corresponding password provided by the user; if not the same, cell phone number log in server will transmit error information to the client and finish the procedure; otherwise, cell phone number log in server will transmit log in request information to public log in server in the instant messaging system, and then step 303 will be executed.

302C comprises the following step 302C1˜302C5:

302C1: if the user selects E-MAIL log in, the client enters an E-MAIL log in interface, the user fills in the E-MAIL address and basic identifier UIN password.

302C2: the client submits log in information comprising this E-MAIL address and UIN password to E-MAIL log in server in the instant messaging system;

302C3: E-MAIL log in server searches E-MAIL binding database to verify binding situation of this E-MAIL address;

302C4: if the E-MAIL address submitted by the user is already bound with a basic identifier UIN, this basic identifier UIN will be obtained, and step 302C5 will be executed; if the E-MAIL address submitted by the user is not bound with any basic identifier UIN, E-MAIL log in server will send error information to the client and finish the procedure;

302C5: E-MAIL log in server searches the database of basic identifier UIN, and judges whether the basic identifier UIN and corresponding password in this database are the same as the basic identifier UIN obtained from the database with which this E-MAIL address is bound and corresponding password provided by the user; if not the same, E-MAIL log in server will transmit error information to the client and finish the flow; otherwise, E-MAIL log in server will transmit log in request information to public log in server in the instant messaging system, and then step 303 will be executed.

Step 303: public log in server executes basic identifier log in operation according to the existing technical scheme.

In addition, the procedure of setting up corresponding relation between basic identifier and secondary identifier can be realized in other ways, like: when the user registers an instant messaging system and fills in user information, the user also fills in some secondary identifiers such as email address and cell phone number, so that instant messaging system can set up a corresponding relation between basic identifier and secondary identifier.

In the above-noted log in procedure, in order to implement multi identifiers log in, the user can log in at first and then be verified according to the established corresponding relation, it is set that the instant messaging system can directly log in log in server with different secondary identifiers, such as: the user logs in the log in server by way of an E-MAIL address and cell phone number, then the instant messaging system verifies whether the secondary identifier is a legal identifier corresponding to the basic identifier according to the said corresponding relation.

The above embodiment is illustrated by taking UIN as the basic identifier and taking cell phone number and E-MAIL address as the secondary identifier, it will be understood by those skilled in the art that other information that can identify the user can be taken as the said basic identifier or secondary identifier, and that there can be more kinds of secondary identifiers to allowing the user to log in.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for multi-identifier log in of instant messaging system, comprising:
A. setting corresponding relations among more than one user identifiers;
B. after receiving a log-in request, instant messaging system allowing the user to log in according to the said corresponding relations among multi user identifiers.

2. A method according to claim 1, wherein, setting at least one mapping database to store the said corresponding relations among more than one user identifiers.

3. A method according to claim 1, wherein, the said more than one identifiers in this method, comprising: basic identifier of instant messaging system and secondary identifier.

4. A method according to claim 3, wherein, the said step A comprising: basic identifier of instant messaging system being bound with at least one secondary identifier.

5. A method according to claim 3, wherein, the said step A comprising: when the user is registering and applying for a basic identifier, instant messaging system automatically setting up corresponding relation between this secondary identifier and the basic identifier according to the secondary identifier in user's information.

6. A method according to claim 4, wherein before the said basic identifier is bound with the said secondary identifier, further comprising: transmitting verification information of this secondary identifier to the identification entity corresponding with the secondary identifier by way of instant messaging system, the basic identifier being bound with secondary identifier if this secondary identifier passes the verification.

7. A method according to claim 6, wherein, the said binding procedure thereof comprising:
a) instant messaging system obtaining basic identifier, secondary identifier as well as other relevant information;
b) instant messaging system transmitting relevant verification request to a identification entity corresponding with current secondary identifier;
c) instant messaging system applying verification according to the obtained corresponding feedback information;
d) after the secondary identifier is verified, current basic identifier and secondary identifier being stored in related mapping database one by one correspondingly.

8. A method according to claim 3, wherein, the said basic identifier of this method is User Identify Number (UIN) or E-mail address; the said secondary identifier is cell phone number or E-mail address or nick name or combination of the former two or three identifiers.

9. A method according to claim 3, wherein, the said step B comprising:
if instant messaging system receives a log-in request adopting a secondary identifier, instant messaging system obtaining the basic identifier corresponding with this secondary identifier in this log-in request according to the said corresponding relation, and then executing basic identifier log in procedure with the obtained basic identifier.

10. A method according to claim 9, wherein, the said log-in request that adopts a secondary identifier in this method comprising secondary identifier and corresponding password of basic identifier, after the said instant messaging system obtains the basic identifier corresponding with the secondary identifier in this request according to the binding relation, the method further comprising: searching the basic identifier database that stores basic identifier and its corresponding password in instant messaging system, judging whether the basic identifier and its corresponding password found in basic identifier database match the basic identifier obtained from the binding relation and corresponding password in the log-in request, if yes, the said basic identifier log-in procedure being executed.

11. A method according to claim 3, wherein, the said step B comprising:
directly logging in the log-in server of instant messaging server through the secondary identifier, and then verifying whether the secondary identifier is a legal identifier corresponding with the basic identifier according to the said corresponding relation.
